(19) United States
(12) Patent Application Publication
(10) Pub. No.: US 2013/0180508 A1
(43) Pub. Date: Jul. 18, 2013

(54) SYSTEM AND METHOD OF CONTROLLING AN AMOUNT OF CONDENSATION IN AN ENGINE AIR INTAKE SYSTEM

(71) Applicants: John A. Zagone, Westmont, IL (US); Paul Gottemoller, Palos Park, IL (US)

(72) Inventors: John A. Zagone, Westmont, IL (US); Paul Gottemoller, Palos Park, IL (US)

(73) Assignee: International Engine Intellectual Property Company LLC, Lisle, IL (US)

(21) Appl. No.: 13/699,305

(22) PCT Filed: May 27, 2010
(86) PCT No.: PCT/US10/36281

§ 371 Date: Nov. 21, 2012

(51) Int. Cl. F02M 25/07

(52) U.S. Cl. CPC F02M 25/07
USPC 123/568.11

(57) ABSTRACT

A condensation collection system for an internal combustion engine having an exhaust gas recirculation system comprises a condensation collection line, a condensation accumulator, and a condensation expulsion line. The condensation collection line is disposed in fluid communication with an air intake system of an internal combustion engine. The condensation accumulator is in fluid communication with the condensation collection line. The condensation collection line being disposed between the air intake system and the condensation accumulator. The condensation expulsion line is in fluid communication with the condensation accumulator. A portion of the condensation expulsion line is disposed in contact with an engine exhaust pipe. The condensation expulsion line has an opening to vent condensation to the atmosphere.

### TECHNICAL FIELD

The present disclosure relates to a system for removing condensation from an air intake system of an engine, and more particularly to a system for removing condensation from the air intake system of the engine and venting the condensation to the atmosphere.

### BACKGROUND

Many modern diesel engines have an exhaust system that features an exhaust gas recirculation (“EGR”) system that routes a portion of engine exhaust gas into an air intake system, such that a mixture of fresh air and engine exhaust is supplied to a combustion chamber during engine operation. One element of engine exhaust from the combustion of diesel fuel is water vapor. In certain instances, the EGR system additionally includes an EGR cooler that reduces the temperature of the exhaust gas in the EGR system, prior to mixing the exhaust gas with fresh air. However, as EGR levels have increased to meet more stringent environmental concerns and emissions requirements, formation of condensation within the air intake system from the water vapor generated during combustion has increased to a level that can be problematic. The increased level of condensation may cause damage to engine components, or may adversely affect combustion of fuel within the engine. Therefore, a need exists for a system to control an amount of condensation present within the air intake system.

### SUMMARY

According to one embodiment, a condensation collection system for an internal combustion engine that has an air intake system, an exhaust system, and an exhaust gas recirculation system is provided. The condensation collection system comprises a first condensation drain line, a first condensation drain line flow valve, a second condensation drain line, a second condensation drain line flow valve, and a condensation discharge port. The first condensation drain line is disposed between an air intake system and an exhaust system of an internal combustion engine. The first condensation drain line is disposed in fluid communication with the air intake system and the exhaust system of the internal combustion engine. The first condensation drain line flow valve is disposed within the first condensation drain line. The first condensation drain line flow valve is positionable between an open position and a closed position. The first condensation drain line flow valve controls fluid communication of the first condensation drain line with the exhaust system. The second condensation drain line is disposed between an exhaust gas recirculation cooler system and the exhaust system. The second condensation drain line is disposed in fluid communication with the exhaust gas recirculation cooler system and the exhaust system. The second condensation drain line flow valve is disposed within the second condensation drain line. The second condensation drain line flow valve is positionable between an open position and a closed position and controls fluid communication of the second condensation drain line with the exhaust system. The condensation discharge port is disposed within the exhaust system and connects at least one of the first condensation drain line and the second condensation drain line to the exhaust system.

According to another embodiment, a condensation collection system for an internal combustion engine that has an air intake system, an exhaust system, and an exhaust gas recirculation system is provided. The condensation collection system comprises a condensation accumulator, a first condensation drain line, a first condensation drain line flow valve, a second condensation drain line, a second condensation drain line flow valve, a condensation injection line, and a condensation discharge port. The condensation accumulator has a plurality of inputs, a vent output, and a drain output. The vent output is in fluid communication with an exhaust system of an internal combustion engine. The drain output is in fluid communication with an air intake system of the internal combustion engine. The first condensation drain line is disposed between an air intake system and the condensation accumulator. The first condensation drain line is disposed in fluid communication with the air intake system and at least one of the plurality of inputs of the condensation accumulator. The first condensation drain line flow valve is disposed within the first condensation drain line. The first condensation drain line flow valve is positionable between an open position and a closed position and controls fluid communication of the first condensation drain line with the condensation accumulator. The second condensation drain line is disposed between an exhaust gas recirculation cooler system and the condensation accumulator. The second condensation drain line is disposed in fluid communication with the exhaust gas recirculation cooler system and the condensation accumulator. The second condensation drain line flow valve is disposed within the second condensation drain line. The second condensation drain line flow valve is positionable between an open position and a closed position and controls fluid communication of the second condensation drain line with the condensation accumulator. The condensation injection line is disposed between the drain output of the condensation accumulator and the air intake system. The condensation discharge port is disposed within the air intake system. The condensation discharge port connects to the condensation injection line.

According to a further embodiment, a condensation collection system for an internal combustion engine that has an air intake system, an exhaust system, and an exhaust gas recirculation system is provided. The condensation collection system comprises a condensation accumulator, a first condensation drain line, a first condensation drain line flow valve, a second condensation drain line, a second condensation drain line flow valve, a condensation injection line, and a condensation discharge port. The condensation accumulator has plurality of inputs, a vent output, and a drain output. The vent output is in fluid communication with an exhaust system of an internal combustion engine. The drain output is in fluid communication with an exhaust gas recirculation system of the internal combustion engine. The first condensation drain line is disposed between an air intake system and the condensation accumulator. The first condensation drain line is disposed in fluid communication with the air intake system and at least one of the plurality of inputs of the condensation accumulator. The first condensation drain line flow valve is disposed within the first condensation drain line. The first condensation drain line flow valve is positionable between an open position and a closed position. The first condensation drain line flow valve controls fluid communication of the first condensation drain line with the condensation accumulator. The second condensation drain line is disposed between an exhaust gas recirculation cooler system and the condensation accumulator. The second condensation drain line is disposed in fluid communication with the exhaust gas recirculation cooler system and the condensation accumulator. The second condensation drain line flow valve is disposed within the second condensation drain line. The second condensation drain line flow valve is positionable between an open position and a closed position and controls fluid communication of the second condensation drain line with the condensation accumulator. The condensation injection line is disposed between the drain output of the condensation accumulator and the exhaust gas recirculation system. The condensation discharge port is disposed within the exhaust gas recirculation system. The condensation discharge port connects to the condensation injection line.

### BRIEF DESCRIPTION OF THE DRAWINGS

FIG. 1 is a schematic diagram showing an engine having an exhaust system with an EGR system and an air intake system with a condensation controlling system according to one embodiment.

FIG. 2 is a schematic diagram showing an engine having an exhaust system with an EGR system and an air intake system with a condensation controlling system according to another embodiment.

FIG. 3 is a schematic diagram showing an engine having an exhaust system with an EGR system and an air intake system with a condensation controlling system according to a further embodiment.

### DETAILED DESCRIPTION

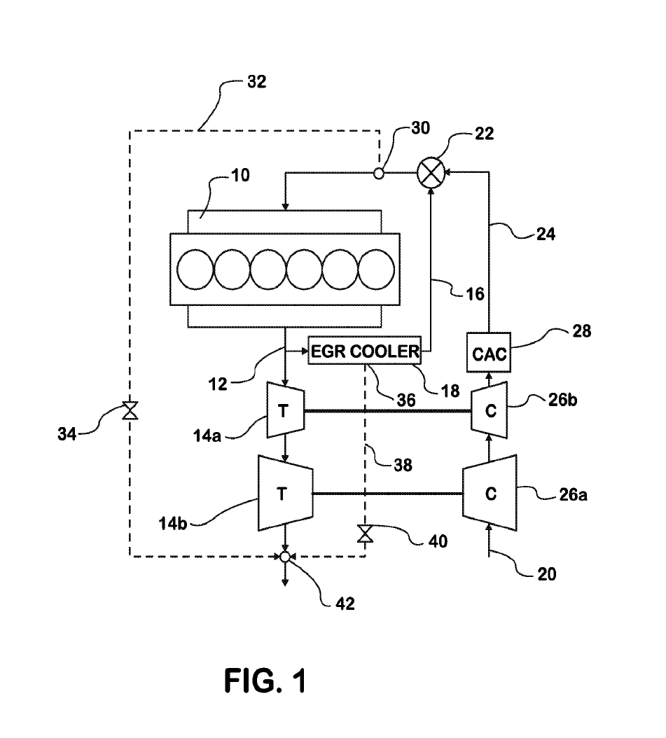

FIG. 1 shows an engine 10 having an exhaust system 12. The exhaust system 12 comprises a first turbine 14a and a second turbine 14b such as, for example, for turbochargers. the exhaust system 12 also has an exhaust gas recirculation (EGR) system 16. The EGR system 16 has an EGR cooler 18 that reduces the temperature of exhaust within the EGR system 16.

The EGR system 16 additionally comprises an EGR connection 22 that delivers exhaust from the EGR system 16 to an air intake system 24. The air intake system 24 delivers fresh air as well as exhaust gas that has passed through the EGR cooler 18 to the engine 10 for use during combustion. The air intake system 24 includes fresh air input 20 that provides fresh air to the engine 10 that may be mixed with the exhaust gas from the EGR system 16. The air intake system comprises a first compressor 26a, and a second compressor 26b, such as from turbochargers, and a charge air cooler 28 that reduces the temperature of intake air within the air intake system 24.

The air intake system 24 additionally has a condensation drain 30 that connects to a first condensation drain line 32. The first condensation drain 32 line is disposed between the air intake system 24 and the exhaust system 12. The first condensation drain line 32 is in fluid communication with the air intake system 24 and the exhaust system 12.

A first condensation drain line flow valve 34 is disposed within the first condensation drain line 32. The first condensation drain line flow valve 34 is positionable between an open position and a closed position to control fluid communication between the air intake system 24 and the exhaust system 12 through the first condensation drain line 32.

The EGR system 16 additionally has a condensation drain 36 that connects to a second condensation drain line 38. The second condensation drain line 38 is disposed between the EGR system 16 and the exhaust system 12. The second condensation drain line 38 is in fluid communication with the EGR system 16 and the exhaust system 12. As shown in FIG. 1, the condensation drain 36 of the EGR system 16 is disposed on the EGR cooler 18, but it is also contemplated that the condensation drain 36 may be elsewhere on the EGR system 16.

A second condensation drain line flow valve 40 is disposed within the second condensation drain line 38. The second condensation drain line flow valve 40 is positionable between an open position and a closed position to control fluid communication between the EGR system 16 and the exhaust system 12 through the second condensation drain line 38.

A condensation discharge port 42 is additionally provided within the exhaust system 12. As shown in FIG. 1, the condensation discharge port 42 connects to the first condensation drain line 32 and the second condensation drain line 38, however, it is contemplated that a separate condensation discharge port may be provided for the first condensation drain line 32 and the second condensation drain line 38.

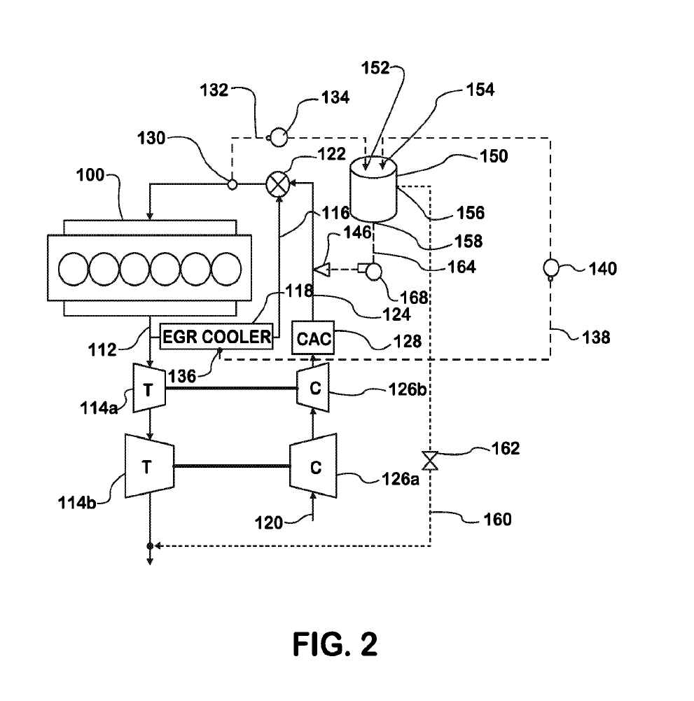

FIG. 2 depicts an engine 110 having an exhaust system 112. The exhaust system 112 comprises a first turbine 114a and a second turbine 14b such as, for example, for turbochargers. The exhaust system 12 also has an exhaust gas recirculation (EGR) system 116. The EGR system 116 has an EGR cooler 118 that reduces the temperature of exhaust within the EGR system 116.

The EGR system 116 additionally comprises an EGR connection 122 that delivers exhaust from the EGR system 116 to an air intake system 124. The air intake system 124 delivers fresh air as well as exhaust gas that has passed through the EGR cooler 118 to the engine 110 for use during combustion. The air intake system 124 includes fresh air input 120 that provides fresh air to the engine 110 that may be mixed with the exhaust gas from the EGR system 116. The air intake system 124 comprises a first compressor 126a, and a second compressor 126b, such as from turbochargers, and a charge air cooler 128 that reduces the temperature of intake air within the air intake system 124.

The air intake system 124 additionally has a condensation drain 130 that connects to a first condensation drain line 132. The first condensation drain line 132 is disposed between the air intake system 124 and a condensation accumulator 150. The first condensation drain line 132 is in fluid communication with the air intake system 124 and the at least one input 152 of the condensation accumulator 150.

A first condensation drain line flow valve 134 is disposed within the first condensation drain line 132. The first condensation drain line flow valve 134 is positionable between an open position and a closed position to control fluid communication between the air intake system 124 and the condensation accumulator 150 through the first condensation drain line 132. The first condensation drain line flow valve 134 additionally is a backflow valve, in that it prevents fluid flow from the condensation accumulator to the condensation drain 130 of the air intake system 124.

The EGR system 116 additionally has a condensation drain 136 that connects to a second condensation drain line 138. The second condensation drain line 138 is disposed between the EGR system 116 and at least a second input 154 of the condensation accumulator 150. The second condensation drain line 138 is in fluid communication with the EGR system 116 and the condensation accumulator 150. As shown in FIG. 2, the condensation drain 136 of the EGR system 116 is disposed on the EGR cooler 118, but it is also contemplated that the condensation drain 136 may be elsewhere on the EGR system 116.

A second condensation drain line flow valve 140 is disposed within the second condensation drain line 138. The second condensation drain line flow valve 140 is positionable between an open position and a closed position to control fluid communication between the EGR system 116 and the condensation accumulator 150 through the second condensation drain line 138.

The condensation accumulator 150 additionally has a vent output 156, and a drain output 158. The vent output 156 connects via a vent line 160 to the exhaust system 112. A vent control valve 162 may be provided within the vent line 160 to control fluid communication between the condensation accumulator 150 and the exhaust system 112. The drain output 158 is connected via a condensation injection line 164 to the air intake system 124. The condensation injection line 164 connects to the air intake system 124 at a condensation discharge port 166. A condensation injection pump 168 is depicted within the condensation injection line 164 between the condensation accumulator 150 and the condensation discharge port 166. The condensation injection pump 168 delivers condensation collected within the condensation accumulator 150 to the condensation discharge port 166 such that the condensation may be injected into the air intake system 124. It is contemplated that gravity may be used to introduce condensation from the condensation accumulator 150 into the condensation discharge port 166 in place of the condensation injection pump 168.

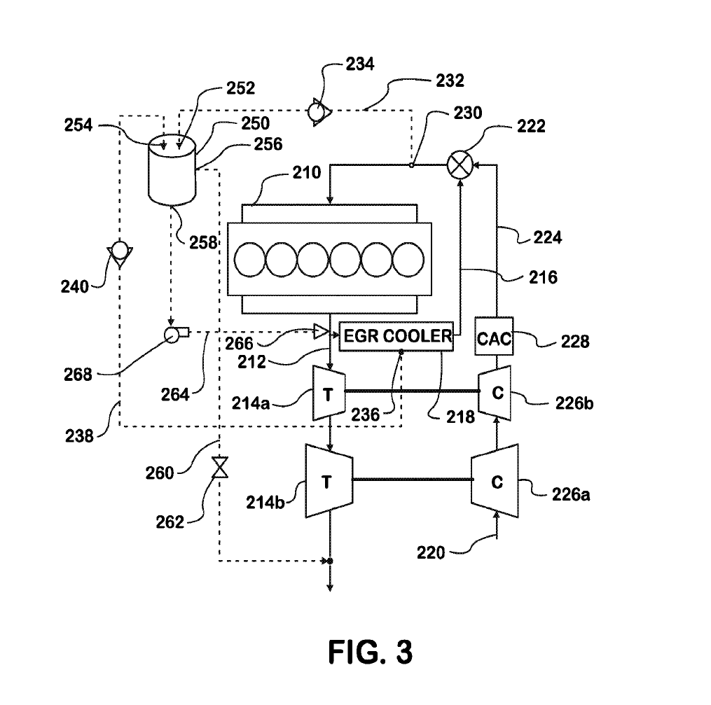

Turning now to FIG. 3, an engine 210 having an exhaust system 212 is shown. The exhaust system 212 comprises a first turbine 214a and a second turbine 214b such as, for example, for turbochargers. The exhaust system 12 also has an exhaust gas recirculation (EGR) system 216. The EGR system 216 has an EGR cooler 218 that reduces the temperature of exhaust within the EGR system 216.

The EGR system 216 additionally comprises an EGR connection 222 that delivers exhaust from the EGR system 216 to an air intake system 224. The air intake system 224 delivers fresh air as well as exhaust gas that has passed through the EGR cooler 218 to the engine 210 for use during combustion. The air intake system 224 includes fresh air input 220 that provides fresh air to the engine 210 that may be mixed with the exhaust gas from the EGR system 216. The air intake system 224 comprises a first compressor 226a, and a second compressor 226b, such as from turbochargers, and a charge air cooler 228 that reduces the temperature of intake air within the air intake system 224.

The air intake system 224 additionally has a condensation drain 230 that connects to a first condensation drain line 232. The first condensation drain line 232 is disposed between the air intake system 224 and a condensation accumulator 250. The first condensation drain line 232 is in fluid communication with the air intake system 224 and the at least one input 252 of the condensation accumulator 250.

A first condensation drain line flow valve 234 is disposed within the first condensation drain line 232. The first condensation drain line flow valve 234 is positionable between an open position and a closed position to control fluid communication between the air intake system 224 and the condensation accumulator 250 through the first condensation drain line 232. The first condensation drain line flow valve 234 additionally is a backflow valve, in that it prevents fluid flow from the condensation accumulator 250 to the condensation drain 230 of the air intake system 224.

The EGR system 216 additionally has a condensation drain 236 that connects to a second condensation drain line 238. The second condensation drain line 238 is disposed between the EGR system 216 and at least a second input 254 of the condensation accumulator 250. The second condensation drain line 238 is in fluid communication with the EGR system 216 and the condensation accumulator 250. As shown in FIG. 3, the condensation drain 236 of the EGR system 216 is disposed on the EGR cooler 218, but it is also contemplated that the condensation drain 236 may be elsewhere on the EGR system 216.

A second condensation drain line flow valve 240 is disposed within the second condensation drain line 238. The second condensation drain line flow valve 240 is positionable between an open position and a closed position to control fluid communication between the EGR system 216 and the condensation accumulator 250 through the second condensation drain line 238. It is contemplated that the second condensation drain line flow valve 240 is also a backflow valve.

The condensation accumulator 250 additionally has a vent output 256, and a drain output 258. The vent output 256 connects via a vent line 260 to the exhaust system 212. A vent control valve 262 may be provided within the vent line 260 to control fluid communication between the condensation accumulator 250 and the exhaust system 212. The drain output 258 is connected via a condensation injection line 264 to the exhaust system 212. The condensation injection line 264 connects to the exhaust system 212 at a condensation discharge port 266. The condensation discharge port 266 is shown as being upstream of the EGR system 216, but it is also contemplated that the condensation discharge port 266 may be located downstream of the location the EGR system 216 connects to the exhaust system 212. A condensation injection pump 268 is depicted within the condensation injection line 264 between the condensation accumulator 250 and the condensation discharge port 266. The condensation injection pump 268 delivers condensation collected within the condensation accumulator 250 to the condensation discharge port 266 such that the condensation may be injected into the exhaust system 212. It is contemplated that gravity may be used to introduce condensation from the condensation accumulator 250 into the condensation discharge port 266 in place of the condensation injection pump 268.

What is claimed is:

1. A condensation collection system for an internal combustion engine, wherein the internal combustion engine has an air intake system, an exhaust system, and an exhaust gas recirculation system, the condensation collection system comprising:
a first condensation drain line disposed between an air intake system and an exhaust system of an internal combustion engine, the first condensation drain line being disposed in fluid communication with the air intake system and the exhaust system;
a first condensation drain line flow valve disposed within the first condensation drain line, the first condensation drain line flow valve being positionable between an open position and a closed position, the first condensation drain line flow valve controlling fluid communication of the first condensation drain line with the exhaust system;
a second condensation drain line disposed between an exhaust gas recirculation cooler system and the exhaust system, the second condensation drain line being disposed in fluid communication with the exhaust gas recirculation cooler system and the exhaust system;
a second condensation drain line flow valve disposed within the second condensation drain line, the second condensation drain line flow valve being positionable between an open position and a closed position, the second condensation drain line flow valve controlling fluid communication of the second condensation drain line with the exhaust system; and
a condensation discharge port disposed in the exhaust system, the condensation discharge port connecting at least one of the first condensation drain line and the second condensation drain line to the exhaust system.

2. The condensation collection system of claim 1, wherein the condensation discharge port connects both the first condensation drain line and the second condensation drain line to the exhaust system.

3. The condensation collection system for an internal combustion engine of claim 1, wherein the condensation discharge port is disposed downstream of a turbocharger in the exhaust system.

4. The condensation collection system for an internal combustion engine of claim 1, further comprising an electronic control module, the electronic control module being disposed in communication with the first condensation drain line flow valve, the electronic control module generating an output to control the position of the first condensation drain line flow valve.

5. The condensation collection system for an internal combustion engine of claim 5, wherein the electronic control module being disposed in communication with the second condensation drain line flow valve, the electronic control module generating an output to control the position of the second condensation drain line flow valve.

6. The condensation collection system for an internal combustion engine of claim 5, wherein the output of the electronic control module to control the position of the first condensation drain line flow valve is based upon engine operating conditions and ambient conditions.

7. A condensation collection system for an internal combustion engine, wherein the internal combustion engine has an air intake system, an exhaust system, and an exhaust gas recirculation system, the condensation collection system comprising:
a condensation accumulator having a plurality of inputs, a vent output, and a drain output, the vent output being in fluid communication with an exhaust system of an internal combustion engine, the drain output being in fluid communication with an air intake system of the internal combustion engine;
a first condensation drain line disposed between an air intake system and the condensation accumulator of the internal combustion engine, the first condensation drain line being disposed in fluid communication with the air intake system and at least one of the plurality of inputs of the condensation accumulator;
a first condensation drain line flow valve disposed within the first condensation drain line, the first condensation drain line flow valve being positionable between an open position and a closed position, the first condensation drain line flow valve controlling fluid communication of the first condensation drain line with the condensation accumulator;
a second condensation drain line disposed between an exhaust gas recirculation cooler system and the condensation accumulator, the second condensation drain line being disposed in fluid communication with the exhaust gas recirculation cooler system and the condensation accumulator;
a second condensation drain line flow valve disposed within the second condensation drain line, the second condensation drain line flow valve being positionable between an open position and a closed position, the second condensation drain line flow valve controlling fluid communication of the second condensation drain line with the condensation accumulator;
a condensation injection line disposed between the drain output of the condensation accumulator and the air intake system; and
a condensation discharge port disposed in the air intake system, the condensation discharge port connected to the condensation injection line.

8. The condensation collection system for an internal combustion engine of claim 7, further comprising a condensation vent line disposed between the vent output of the condensation accumulator and an exhaust system.

9. The condensation collection system for an internal combustion engine of claim 8, wherein the condensation vent line attaches to the exhaust system downstream of a turbocharger in the exhaust system.

10. The condensation collection system for an internal combustion engine of claim 7, further comprising a condensation injection pump, the condensation injection pump being disposed in fluid communication with the condensation injection line.

11. The condensation collection system for an internal combustion engine of claim 7, wherein the first condensation drain line flow valve additionally comprises a check valve to prevent backflow.

12. The condensation collection system for an internal combustion engine of claim 7, wherein the second condensation drain line flow valve additionally comprises a check valve to prevent backflow.

13. The condensation collection system for an internal combustion engine of claim 7 further comprising an electronic control module, the electronic control module being disposed in communication with the first condensation drain line flow valve, the electronic control module generating an output to control the position of the first condensation drain line flow valve.

14. The condensation collection system for an internal combustion engine of claim 13, wherein the electronic control module being disposed in communication with the second condensation drain line flow valve, the electronic control module generating an output to control the position of the second condensation drain line flow valve.

15. A condensation collection system for an internal combustion engine, wherein the internal combustion engine has an air intake system, an exhaust system, and an exhaust gas recirculation system, the condensation collection system comprising:
a condensation accumulator having plurality of inputs, a vent output, and a drain output, the vent output being in fluid communication with an exhaust system of an internal combustion engine, the drain output being in fluid communication with an exhaust gas recirculation system of the internal combustion engine;
a first condensation drain line disposed between an air intake system and the condensation accumulator of the internal combustion engine, the first condensation drain line being disposed in fluid communication with the air intake system and at least one of the plurality of inputs of the condensation accumulator;
a first condensation drain line flow valve disposed within the first condensation drain line, the first condensation drain line flow valve being positionable between an open position and a closed position, the first condensation drain line flow valve controlling fluid communication of the first condensation drain line with the condensation accumulator;
a second condensation drain line disposed between an exhaust gas recirculation cooler system and the condensation accumulator, the second condensation drain line being disposed in fluid communication with the exhaust gas recirculation cooler system and the condensation accumulator;
a second condensation drain line flow valve disposed within the second condensation drain line, the second condensation drain line flow valve being positionable between an open position and a closed position, the second condensation drain line flow valve controlling fluid communication of the second condensation drain line with the condensation accumulator;
a condensation injection line disposed between the drain output of the condensation accumulator and the exhaust gas recirculation system; and
a condensation discharge port disposed within the exhaust gas recirculation system, the condensation discharge port connected to the condensation injection line.

16. The condensation collection system for an internal combustion engine of claim 15, further comprising a condensation vent line disposed between the vent output of the condensation accumulator and an exhaust system.

17. The condensation collection system for an internal combustion engine of claim 15, further comprising a condensation injection pump, the condensation injection pump being disposed in fluid communication with the condensation injection line.

18. The condensation collection system for an internal combustion engine of claim 15, wherein the first condensation drain line flow valve additionally comprises a check valve to prevent backflow.

19. The condensation collection system for an internal combustion engine of claim 15 further comprising an electronic control module, the electronic control module being disposed in communication with the first condensation drain line flow valve, the electronic control module generating an output to control the position of the first condensation drain line flow valve.

20. The condensation collection system for an internal combustion engine of claim 15, wherein the electronic control module being disposed in communication with the second condensation drain line flow valve, the electronic control module generating an output to control the position of the second condensation drain line flow valve.
